(19) United States
(12) Patent Application Publication
(10) Pub. No.: US 2023/0306071 A1
(43) Pub. Date: Sep. 28, 2023

(54) TRAINING WEB-ELEMENT PREDICTORS USING NEGATIVE-EXAMPLE SAMPLING

(71) Applicant: Klarna Bank AB, Stockholm (SE)

(72) Inventors: Stefan Magureanu, Solna (SE); Riccardo Sven Risuleo, Stockholm (SE)

(21) Appl. No.: 17/701,595

(22) Filed: Mar. 22, 2022

(51) Int. Cl. G06F 16/958; G06N 20/20; G06K 9/62

(52) U.S. Cl. CPC G06F 16/958; G06N 20/20; G06K 9/6259; G06K 9/6268

(57) ABSTRACT

A first set of objects is obtained, where an object of the first set of objects is assigned a classification. A first dataset is generated based at least in part on the first set of objects, where the first dataset includes a value corresponding to at least one characteristic of the object and a label corresponding to the classification. A machine learning model is trained to classify objects using the first dataset as training input. A set of predictions that includes incorrect predictions for a second set of objects is generated using the machine learning model. A second dataset that includes negative-examples that correspond to the incorrect predictions is generated. The machine learning model is retrained using the second dataset as training input.

### BACKGROUND

In the field of automating interaction with web pages, identifying web page elements with confidence can be difficult and time-consuming given the sheer number of objects in the average web page. A machine learning classifier algorithm may attempt to classify each of the web page elements by estimating a probability of it belonging to a classification of interest. Training a machine learning classifier algorithm on every possible type of web page element is impractical, so a machine learning classifier algorithm may be trained on a sampling of web elements from a sampling of web pages. However, due to the large number of web page elements that may never have been seen during training, there is a high chance that outliers are incorrectly assigned high probabilities by the machine learning classifier algorithm. For example, even if a classifier algorithm has a 95% accuracy, a real-world web page may have 1,500 to 2,000 web elements. Processing all of the web elements on a web page may be very slow for the algorithm and may result in up to 75 to 100 mis-classified web elements. Therefore, a need exists to train machine learning classifier algorithms more efficiently and for the trained machine learning classifier algorithms to estimate probabilities more accurately for unfamiliar web elements.

### BRIEF DESCRIPTION OF THE DRAWINGS

Various techniques will be described with reference to the drawings, in which:

FIG. 1A illustrates an example of training web-element predictors in accordance with an embodiment;

FIG. 1B illustrates an example of re-training web-element predictors in accordance with an embodiment;

FIGS. 2A-2C illustrate examples of different schemes for sampling nodes to use as negative-examples in accordance with an embodiment;

FIG. 3 illustrates an example of how using negative-example sampling improves accuracy of web-element predictors in accordance with an embodiment;

FIG. 4 is a flowchart that illustrates an example of using negative-example sampling to train web-element predictors in accordance with an embodiment; and

FIG. 5 illustrates a computing device that may be used in accordance with at least one embodiment/an environment in which various embodiments can be implemented.

### DETAILED DESCRIPTION

Techniques and systems described below relate to improving the accuracy of machine learning models trained to identify a specific object of interest, such as a particular web element, from among a plurality of objects. In one example, a set of document object model (DOM) trees that correspond to a set of sample web pages is obtained, where an individual DOM tree of the set of DOM trees includes a node that has been determined to correspond to a particular classification, wherein the node represents an element on a web page. In the example, a first training dataset from the set of DOM trees is generated, with the first training dataset including at least one pair of values that include a feature vector corresponding to a node in a first DOM tree of a first web page and a label corresponding to the particular classification. Further in the example, the machine learning model is trained for at least one epoch to classify DOM nodes of web pages by providing the first training dataset as input to a machine learning model that implements a classifier, thereby producing a first trained machine learning model.

Still further in the example, a prediction set is generated by providing a set of feature vectors derived from nodes of a second DOM tree of a second web page to the first trained machine learning model, where the prediction set includes top-ranked nodes that do not correspond to the particular classification. Then, in the example, the top-ranked nodes are indicated as being confusing to the classifier. Finally, in the example, the machine learning model is re-trained by providing a second training dataset that includes at least the top-ranked nodes as negative-examples to the machine learning model, thereby producing a second trained machine learning model.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Techniques described and suggested in the present disclosure improve the field of computing, especially the field of machine learning, by selectively modifying the training set to cause the trained machine learning algorithm to be more accurate using the same source of training data. Additionally, techniques described and suggested in the present disclosure improve the accuracy of machine learning algorithms trained to recognize an object of interest from a multitude of other objects by re-training the machine learning model using high-scoring negative-examples identified in the initial training. Moreover, techniques described and suggested in the present disclosure are necessarily rooted in computer technology in order to overcome problems specifically arising with the ability of web automation software (e.g., plug-ins and browser extensions, automated software agents, etc.) to find the correct elements of a web page to interact with by using machine learning techniques to more accurately predict which web element is the element of interest.

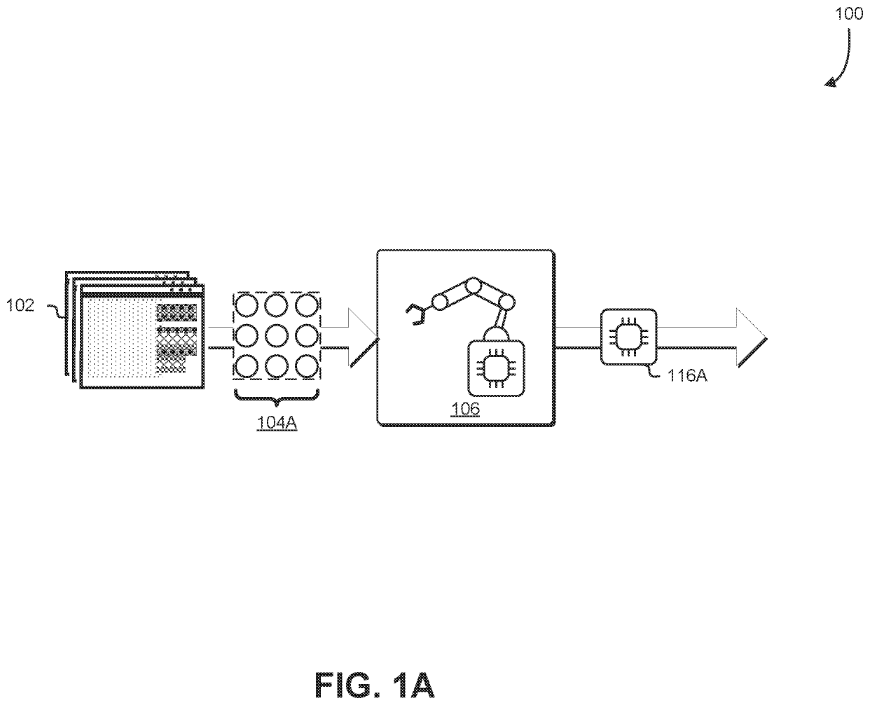

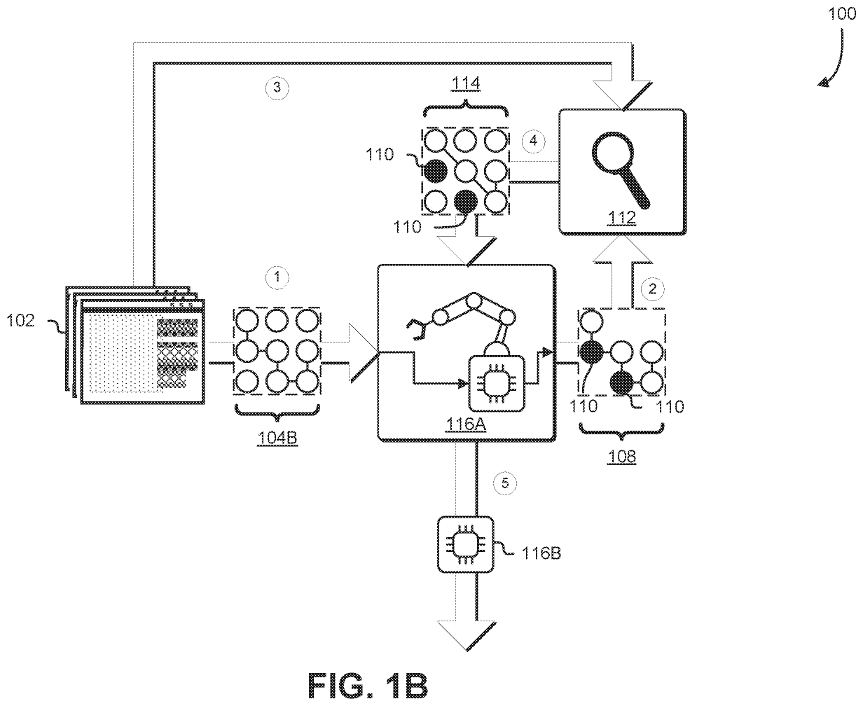

FIG. 1A illustrates an aspect of a system 100 in which an embodiment may be practiced. As illustrated in FIG. 1A, the system 100 may include a machine learning model 106 that obtains an initial training dataset 104A derived from one or more web pages 102 to produce an initially trained machine learning model 116A.

The one or more web pages 102, from which at least a portion of the initial training dataset 104A is derived, may be a user interface to a computing resource service that a user may interact with using an input device, such as a mouse, keyboard, or touch screen. The one or more web pages 102 may include various interface elements, such as text, images, links, tables, and the like. In an example, the one or more web pages 102 may operate as interfaces to a service of an online merchant (also referred to as an online merchant service) that allows a user to obtain, exchange, or trade goods and/or services with the online merchant and/or other users of the online merchant service.

Additionally, or alternatively, the one or more web pages 102 may allow a user to post messages and upload digital images and/or videos to servers of the entity hosting the one or more web pages 102. In another example, the one or more web pages 102 may operate as interfaces to a social networking service that enables a user to build social networks or social relationships with others who share similar interests, activities, backgrounds, or connections with others. Additionally, or alternatively, the one or more web pages 102 may operate as interfaces to a blogging or microblogging service that allows a user to transfer content, such as text, images, or video. Additionally, or alternatively, the one or more web pages 102 may be interfaces to a messaging service that allow a user to send text messages, voice messages, images, documents, user locations, live video, or other content to others.

In various embodiments, the system of the present disclosure may obtain (e.g., by downloading) the one or more web pages 102 and extract various interface elements, such as HyperText Markup Language (HTML) elements, from the one or more web pages 102. The one or more web pages 102 may be at least one web page hosted on a service platform. In some examples, a “service platform” (or just “platform”) refers to software and/or hardware through which a computer service implements its services for its users. In embodiments, the various form elements of the one or more web pages 102 may be organized into a document object model (DOM) tree hierarchy with nodes of the DOM tree representing web page elements. In some examples, the interface element may correspond to a node of an HTML form.

In some examples, a node represents information that is contained in a DOM or other data structure, such as a linked list or tree. Examples of information include, but are not limited to, a value, a clickable element, an event listener, a condition, an independent data structure, etc. In some examples, a form element refers to clickable elements which may be control objects that, when activated (such as by clicking or tapping), cause the one or more web pages 102 or any other suitable entity to elicit a response. In some examples, an interface element is associated with one or more event listeners which may be configured to elicit a response from the one or more web pages 102 or any other suitable entity. In some examples, an event listener may be classified by how the one or more web pages 102 responds. As an illustrative example, the one or more web pages 102 may include interfaces to an online library and the one or more web pages 102 may have nodes involving “Add to Queue” buttons, which may have event listeners that detect actual or simulated interactions (e.g., mouse clicks, mouse over, touch events, etc.) with the “Add to Queue” buttons. In the present disclosure, various elements may be classified into different categories. For example, certain elements of the one or more web pages 102 that have, when interacted with, the functionality of adding an item to a queue, may be classified as “Add to Queue” elements, whereas elements that cause the interface to navigate to a web page that lists all of the items been added to the queue may be classified as “Go to Queue” or “Checkout” elements.

The initial training dataset 104A may be a set of nodes representing elements from the one or more web pages 102. The initial training dataset 104 may include feature vectors and labels corresponding to nodes that were randomly selected, pseudo-randomly selected, or selected according to some other stochastic or other selection method from the one or more web pages 102. Firstly, in the initialization, the initial training dataset 104 may be assigned a label by a human operator. In one example, the one or more web pages 102 is a web page for a product or service, and the initial training dataset 104A may be a set of nodes, with at least one node of interest labeled as corresponding to a particular category by the human operator. In some implementations, each web page in the initial training dataset 104 has just a solitary node labeled as corresponding to the particular category. In some examples, the label is a name or an alphanumerical code assigned to a node, where the label indicates a category/classification of the type of node. Other nodes of the web page may be unlabeled or may be assigned different categories/classifications. In the example 100, the initial training dataset 104A may be used to train the machine learning model 106A, thereby resulting in the initially trained machine learning model 116A. In this manner, the machine learning model 116A may be trained to recognize elements of interest in web pages as well as their functions.

Nodes from each page of the one or more web pages 102 likewise have at least one node labeled by a human operator as belonging to the particular category/classification. It is also contemplated that the various web pages of the one or more web pages 102 may be user interfaces to the same or different computing resource service (e.g., different merchants). In addition to being labeled or unlabeled, each node of the initial training dataset 104 may be associated with a feature vector comprising attributes of the node. In some examples, a feature vector is one or more numeric values representing features that are descriptive of the object. Attributes of the node transformable into values of a feature vector could be size information (e.g., height, width, etc.), the HTML, of the node broken into tokens of multiple strings (e.g., [“input”, “class”, “goog”, “toolbar”, “combo”, “button”, “input,” “jfk”, “textinput”, “autocomplete”, “off”, “type”, “text”, “aria”, “autocomplete”, “both”, “tabindex”, “aria”, “label”, “zoom”]) such as by matching the regular expression /[A-Z]*[a-z]*/, or some other method of transforming a node into a feature vector.

The initial training dataset 104A may be provided as training input to the machine learning model 106 so as to produce the initially trained machine learning model 116A capable of recognizing and categorizing web pages. The initially trained machine learning model 116A may be a machine learning model that has been trained, using the initial training dataset 104A, to recognize and classify nodes of a web page. In the present disclosure, the initially trained machine learning model, rather than being the final product, may be utilized to identify gaps in the initial training dataset 104A. For example, feature vectors derived from one or more web pages (not in the initial training dataset 104A) may be provided as input to the initially trained machine learning model 116A, such as described below in regards to FIG. 1B, and an operator may evaluate the accuracy of the predicted classifications by the initially trained machine learning model 116A. Nodes that the initially trained machine learning model 116A gives too high of a probability of belonging to a wrong category may be flagged as “hard” (i.e., as in difficult for the initially trained machine learning model 116A to classify correctly) and may be included in a re-training dataset (the re-training dataset 114), as described below.

FIG. 1B illustrates an aspect of a system 100 in which an embodiment may be practiced. FIG. 1B illustrates an evaluation and re-training of the initially trained machine learning model 116A. Accordingly, as illustrated in FIG. 1B, the system 100 may further include a machine learning model 106 that (1) obtains input data 104B derived from the one or more web pages 102 to produce a set of node predictions 108. A negative-example identification module 112 may (2) receive the set of node predictions 108 and identify negative-examples 110. The negative-examples 110 may be (3) combined with nodes derived from the one or more web pages 102 to (4) produce a re-training dataset 114, which may be used to improve the efficiency and confidence of the model by re-training the initially trained machine learning model to (5) produce the re-trained machine learning model 116B. In this manner, the re-trained machine learning model 116B may be generated to more accurately identify of web page elements than the initially trained machine learning model 116A.

The one or more web pages 102 may be the same or different set of web pages as the one or more web pages 102 of FIG. 1A, but it is contemplated that for the purpose of determining the accuracy of the initially trained machine learning model 116A that the input data 104B should be derived from different web pages from the one or more web pages 102 than the web pages from which the initial training dataset 104A were derived. However, as with the one or more web pages 102, the one or more web pages 102 may be user interfaces to a computing resource service that a user may interact with using an input device, such as a mouse, keyboard, or touch screen. Likewise, the one or more web pages 102 may include various interface elements, such as text, images, links, tables, and the like.

The input data 104B may be a set of nodes representing elements from the one or more web pages 102. At least one node of the one or more web pages 102 may be known to correspond to a particular category of interest but may be unlabeled for the purposes of determining whether the initially trained machine learning model assigns the highest probability of being the particular category of interest to the at least one node. It is contemplated that the input data 104B may be include sets of nodes from other web pages in addition to nodes from the one or more web pages 102. Each set of nodes from the other web pages may likewise have at least one node labeled by a human operator as belonging to the particular category/classification. In addition to being labeled or unlabeled, each node of the initial training dataset 104 may be associated with a feature vector comprising attributes of the node. Attributes of the node could include size information, (e.g., height, width, etc.), the HTML of the node broken into tokens of multiple strings, or some other characteristic or property of the node.

An evaluation of the machine learning model 116A may be performed using the input data 104B. The input data 104B may include a set of nodes representing elements from the one or more web pages 102. The input data 104 may contain nodes corresponding to a category/classification of interest, represented as nodes connected by lines. The nodes of the input data 104B may be initially unlabeled at least until the probability of each node being the category/classification of interest is determined by the initially trained machine learning model 116A. The machine learning model 116A may be trained, such as in the manner described in relation to FIG. 1A, to recognize the functions of objects (such as represented by the input data 104B) in a dataset. The machine learning model 116A may output a set of node predictions 108, wherein some of the set of node predictions 108 may be incorrect. For example, the set of node predictions 108 may include a set of probabilities of the nodes corresponding to the category/classification of interest, where nodes that do not correspond to a category/classification of interest but were given a high probability of corresponding to the category/classification of interest (e.g., above the probability of an actual node corresponding to the category/classification of interest—also referred to as a “true positive” element—or a probability above a threshold probability) may be considered “mislabeled,” “incorrectly predicted,” or “negative examples.” In other words, the negative-examples 110 may be incorrectly predicted to be a type of element that they are not functionally equivalent to.

In some examples, “functional equivalency” refers to performing the same or equivalent function or to representing the same or equivalent value. For example, an image object and a button object that, when either is activated (such as by clicking or tapping), submits the same form as the other or opens the same web page as the other may be said to be functionally equivalent. As another example, a first HTML element with an event listener that calls the same subroutine as an event listener of a second HTML element may be said to be functionally equivalent to the second HTML element. In other words, the requests produced by selection of the nodes match each other. In another example, two values may match if they are not equal but equivalent. As another example, two values may match if they correspond to a common object (e.g., value) or are in some predetermined way complementary and/or they satisfy one or more matching criteria. Generally, any way of determining whether there is a match may be used. Determination of whether the requests match may be performed by obtaining text strings of the requests, determining the differences between the text strings (e.g., calculating a distance metric between two text strings), and determining whether the differences between the text strings are immaterial (e.g., whether the distance metric is below a threshold).

Thus, functional equivalency can include but is not limited to, for example, equivalent values, equivalent functionality when activated, equivalent event listeners, and/or actions that elicit equivalent responses from an interface, network, or the one or more web pages 102. Additionally, or alternatively, functional equivalency may include equivalent conditions that must be fulfilled to obtain a result or effect.

The set of node predictions 108 may be a dataset that is output by the machine learning model 116A. Each node prediction of the set of node predictions 108 may include the node name/identity and a probability of the node corresponding to a category/classification of interest. For each web page, the node assigned the highest probability of being the category/classification of interest ideally will be the object of interest that falls under that category/classification. However, it is contemplated in this disclosure that the initially trained machine learning model 116A may occasionally assign a higher probability to the wrong node than to the true positive node. That is, the initially trained machine learning algorithm may incorrectly rank nodes that do not correspond to the particular classification of interest higher than the true positive element. In FIG. 1B, nodes having the highest computed probabilities that also correspond to true positive nodes are illustrated as white circles, whereas nodes having the highest computed probabilities but that correspond to a wrong node (a node other than a true positive node) are illustrated as black circles. These wrong nodes are referred to in the present disclosure as “negative-examples.”

The set of node predictions 108 may include negative-examples, such as the negative-examples 110. The negative-examples 110 may be one or more examples that may be assigned too high of a probability of being the category/classification of interest or otherwise mislabeled by the initially trained machine learning model 116A. For example, the negative-examples 110 may correspond to web page elements. As an example, a negative-example may be assigned a higher probability to be an “Add to Cart” button by the initially trained machine learning model 116A, but in reality the negative-example is a “Checkout” button and some other element (the true positive element) with a lower probability is the real “Add to Cart” button. The set of node predictions 108 may be fed into the negative-example identification module 112, wherein the negative-examples 110 are identified and are combined into the re-training dataset 114 and further fed back into the machine learning model 116A.

The negative-example identification module 112 may be configured to identify the negative-examples 110 associated with the set of node predictions 108. The negative-example identification module 112 may be implemented in hardware or software. For example, the negative-example identification module 112 may, for the one or more web pages 102 and the input data 104B, obtain an indication of which node corresponds to the true positive element. Based on this indication, and the probability assigned to the true positive element by the initially trained machine learning model, the negative-example identification module 112 may determine that all nodes of the one or more web pages 102 that have been assigned higher probabilities than the probability assigned to the true positive element are the negative-examples 110. Additionally, or alternatively, the negative-example identification module 112 may determine a fixed number (e.g., top 5, top 10, etc.) of the nodes from the set of node predictions 108 with the highest probabilities of corresponding to the category/classification of interest, not counting the true positive element, are the negative-examples 110. Still additionally, or alternatively, the negative-example identification module 112 may determine that all nodes from the set of node predictions 108 with higher probabilities than a threshold probability of being the category/classification of interest, other than the true positive element, are the negative-examples 110.

After the negative-example identification module 112 has identified the negative-examples 110, the negative-example identification module 112 may combine the negative-examples 110 with another dataset derived from the one or more web pages 102, such as the initial training dataset 104A or other dataset, to create the re-training dataset 114.

The re-training dataset 114 may be a dataset that may contain the negative-examples 110 in addition to a dataset derived from the one or more web pages 102. The re-training dataset 114 may be used to update the machine learning model 116A to make it more accurate or may be used to re-train the machine learning model 106 of FIG. 1A to produce the re-trained machine learning model 116B. It is contemplated that the machine learning model being re-trained in FIG. 1B is the same type of machine learning model that was used in the initial training in FIG. 1A.

The re-trained machine learning model 116B may aid in predicting the functionality of other elements within a dataset. For example, presented with a web page for a product or service, the re-trained machine learning model 116B may be able to predict which object or objects within the web page add items to a queue when activated, which objects cause a browser to navigate to a cart page when selected, which objects represent the price of an item, and so on. Similarly, given a cart web page, the re-trained machine learning model 116B, once trained, may be able to distinguish which of the many values on the page correspond to a unit price, correspond to a quantity, correspond to a total, correspond to a shipping amount, correspond to a tax value, correspond to a discount, and so on. Once the functionality of an object is known, integration code may be generated that causes a device executing the integration code to be able to simulate human interaction with the object. For example, suppose a node is identified to include an event listener that, upon the occurrence of an event (e.g., an onclick event that indicates selection of an item), adds an item to an online shopping cart. Integration code may be generated to cause an executing device to dynamically add the item to the online shopping cart by simulating human interaction (e.g., by automatically triggering the onclick event). Being able to identify the functionality of the nodes in the web page, therefore, enables the system 100 to generate the correct integration code to trigger the event and automate the process of adding items to an online shopping cart.

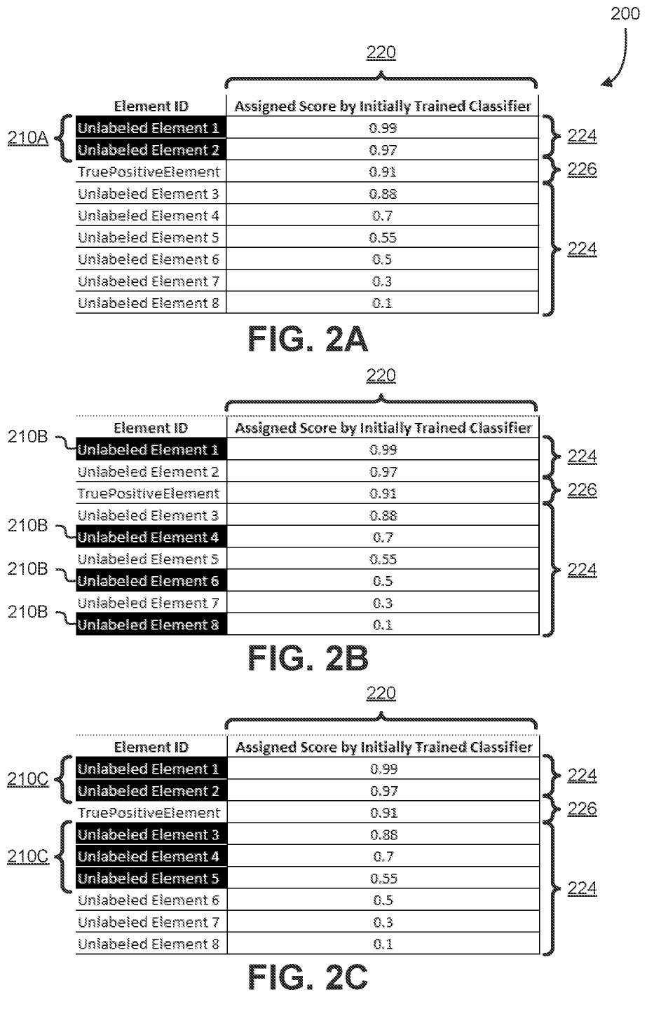

FIGS. 2A-2C illustrate aspects of embodiments 200 that may be practiced. In particular, FIGS. 2A-2C illustrate alternate strategies for choosing negative-examples 210A-10C from unlabeled elements 224 to be used in a re-training dataset for a machine learning model. As illustrated in FIG. 2, the aspects of the embodiments 200 may include a set of scores, such as scores 220, in which nodes are given a score or probability based at least in part on the confidence that the node is correctly labeled.

The scores 220 may be output from a machine learning model, such as the initially trained machine learning model of FIGS. 1A-1B, trained to output a score indicating a likelihood that a given element corresponds to a category/classification of interest. In FIGS. 2A-2C, the scores 220 may be ranked/ordered based on an assigned score. The elements and scores are illustrated in FIGS. 2A-2B in order of decreasing probability, but it is contemplated that, depending on implementation, the system of the present disclosure may not necessarily order the scores in this manner.

In the illustrated examples of FIGS. 2A-2C, the elements being ranked include unlabeled elements 224 and the true positive element 226. The true positive element 226 may be the element identified by a human operator as being the actual element, from among a set of elements of a web page, having the category/classification that the machine learning model was trained to recognize. For example, if an “Add to Cart” button is the category/classification of interest, the true positive element 226 may be that button. On the other hand, the unlabeled elements 224 may be all of the other elements in the web page that are not of interest by the system of the present disclosure. For example, one of the unlabeled elements 224 may be a graphical element representing an email link, another of the unlabeled elements 224 may be a “Help” button, and another of the unlabeled elements 224 may be a “Search” textbox—none of which is the category/classification/type of interest in this particular example (but could be in some other implementation).

The unlabeled elements 224 and the true positive element 226, for ease of illustration, may be elements from a single web page. However, it is contemplated that in some implementations, the scores from multiple web pages could be derived from multiple sources, such as multiple web pages. In such a case, the scores and elements from each web page may be combined and ordered such that there may be multiple true positive elements and unlabeled elements from the multiple web pages.

The unlabeled elements 224 and the true positive element 226 in FIGS. 2A-2C may be derived from multiple arbitrary web pages so as to accumulate a reasonable number of the negative-examples 210A-10C to use in the re-training set. For ease of illustration, however, the unlabeled elements 224 and the true positive element 226 shown in FIGS. 2A-2C are assumed to be derived from a single source, such as the one or more web pages 102 in FIGS. 1A-1B. The true positive element 226 in FIG. 2A-2C may correspond to the element having the functionality being sought (the element or node of interest). As illustrated in FIGS. 2A-2C, the true positive element 226 may not always have the highest probability of being the element of interest.

The unlabeled elements 224 and the true positive element 226 may have an assigned score by an initially trained machine learning model. In some examples, the assigned score by the initially trained machine learning model may be a probability between 0 and 1, wherein 0 is the lowest confidence and 1 is the highest confidence. However, it is also contemplated that, in some embodiments, this case may be the opposite.

After the machine learning model is initially trained (e.g., initialized, such as according to FIG. 1A), elements of a web page, such as from the one or more web pages 102, may be transformed into feature vectors and input into the initially trained machine learning model (such as machine learning model 116A in FIGS. 1A-1B). The initially trained machine learning model may assign probabilities to each of the elements in the web page. The probabilities may be the probability of any node being the node of interest. For example, if the element of interest was an “Add to Cart” button, the machine learning model estimates the probabilities of each of the sampled unlabeled elements 224 being the “Add to Cart” button. Each of FIGS. 2A-2B depict a ranking of elements on a web page.

FIG. 2A depicts an embodiment where the negative-examples 210A are selected. The strategy for selecting the negative-examples 210A is to select from the unlabeled elements 224 the examples that have higher probabilities for being the element of interest than the actual true positive element 226. These are selected to be our negative examples, as illustrated by the highlighting in black. FIG. 2B depicts an alternative embodiment where the negative-examples 210B are selected. The strategy for selecting the negative-examples 210B is to select the unlabeled elements 224 diversely/distributively across the length of the list, illustrated by the highlighting in black. In turn, this ensures a diverse training set, where we have negative examples with high, low, and medium probabilities. Selection of such negative-examples 210B could be made randomly, pseudo-randomly, or according to some other stochastic or other suitable selection method for achieving this goal.

FIG. 2C depicts yet another alternative embodiment where the top-N negative-examples 210C are selected illustrated by the highlighting in black. The strategy for selecting the negative-examples 210C is to select from the unlabeled elements 224 the elements with the N-highest probabilities (with N being five in the illustrative embodiment 2C) to be the negative-examples 210C. Thus, this may include unlabeled elements 224 with lower scores/probabilities than the true positive element 226 or may even exclude unlabeled elements with higher probabilities than the true positive element 226 but that are less than the top N-highest probabilities (this example is not depicted in FIGS. 2A-2C). It is possible, although not shown, that the true positive element could be the highest-ranked element, but the next N unlabeled elements, which are technically correctly ranked with lower scores/probabilities than the true positive element, would be selected for retraining in accordance with the techniques described in the present disclosure. It is further contemplated that techniques described in the present disclosure are performed as a result of at least some of the unlabeled elements 224 having scores that reach a value relative to a threshold (for example, exceeding a threshold of 0.5). In some implementations, the method for selecting the negative examples may be to select those unlabeled elements 224 that exceed such a threshold. It is contemplated, however, that N may be any integer suitable for a particular implementation. The number (N) of top unlabeled elements may be user defined, statically defined, or otherwise generated in any suitable manner.

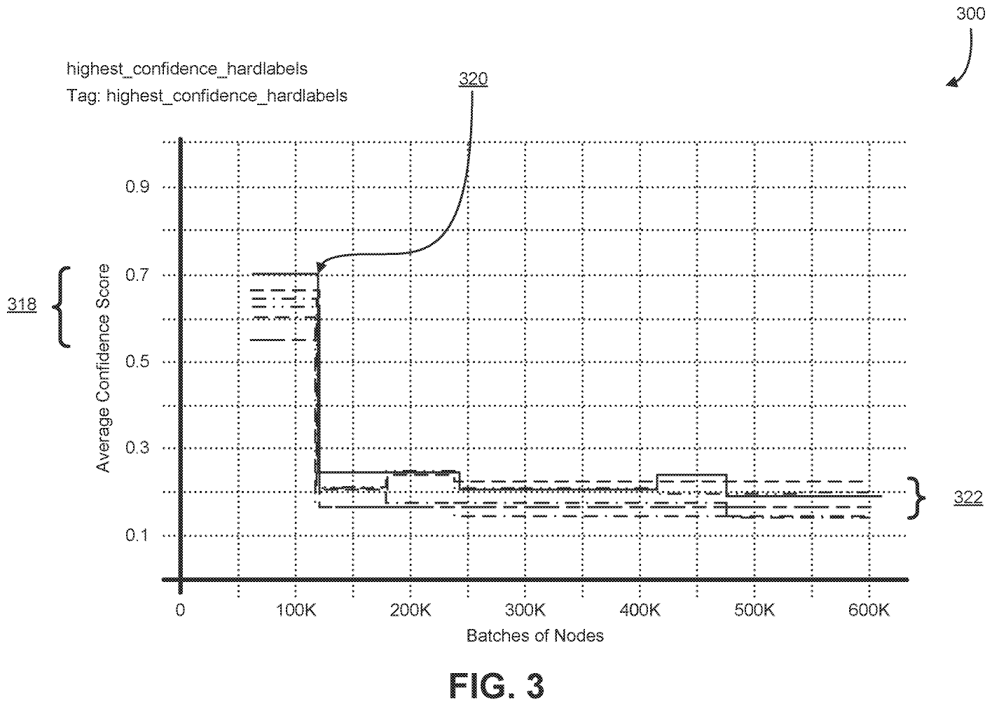

FIG. 3 illustrates an example 300 of the performance improvements provided by embodiments of the present disclosure. In particular, FIG. 3 demonstrates the difference between the training of the initially trained machine learning model 116A and the re-trained machine learning model 116B. FIG. 3 illustrates the relationship between confidence values over training time of a machine learning model, such as machine learning models 116A-16B. The confidence values may be the probability (e.g., as the maximum confidence) assigned to any negative node on the page. That is to say, the maximum probability that any negative node corresponds to a category/classification of interest.

Each line of the graph may illustrate a different category/classification of interest (e.g., “Add to Cart Button,” “Checkout Button,” “Product Image,” “Product Description,” etc.). The maximum confidences assigned to negative-examples 318 may be the highest confidence scores assigned by an initially trained machine learning model, such as the initially trained machine learning model 116A of FIG. 1A, to an element that is not actually the true positive element in a given web page. As can be seen, even after training the machine learning model (e.g., machine learning model 106) on more than 100,000 nodes, the highest confidence scores assigned to a label that is not the true positive element is still quite high—between 55% and 70% confidence. However, when these negative-examples 318 are included in a re-training dataset, the maximum confidences assigned to negative-examples 319 drops off significantly, as illustrated by the drop-off point 320.

The drop-off point 320 may be the point at which the negative nodes are fed into the machine learning model 106 to produce the re-trained machine learning model 116B. The negative nodes being added may result in a lowering of the confidence values for elements that are not actually the true positive elements, illustrated as the drop-off point 320. The maximum confidences assigned to negative-examples 322 illustrate that the highest confidence scores assigned by a re-trained machine learning model, such as the re-trained machine learning model 116B, are now significantly lower; e.g., having probabilities of about 15-20% of being an element of interest after the model was re-trained on 150,000-600,000 nodes. Consequently, the true positive element is more likely to be assigned a higher confidence score of being a category/classification of interest (e.g., an “Add to Cart” label) in a web page than any other node on the page.

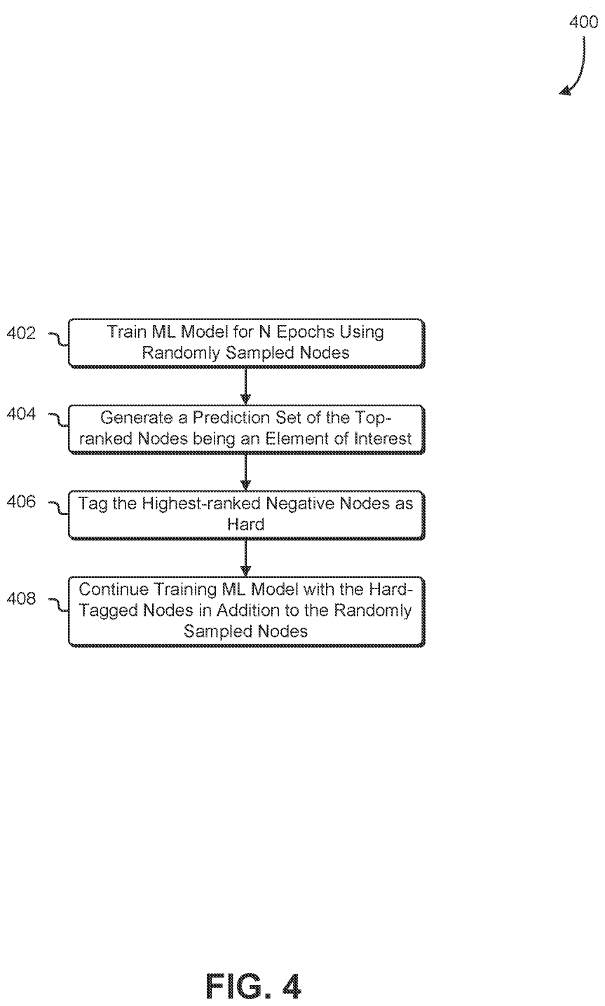

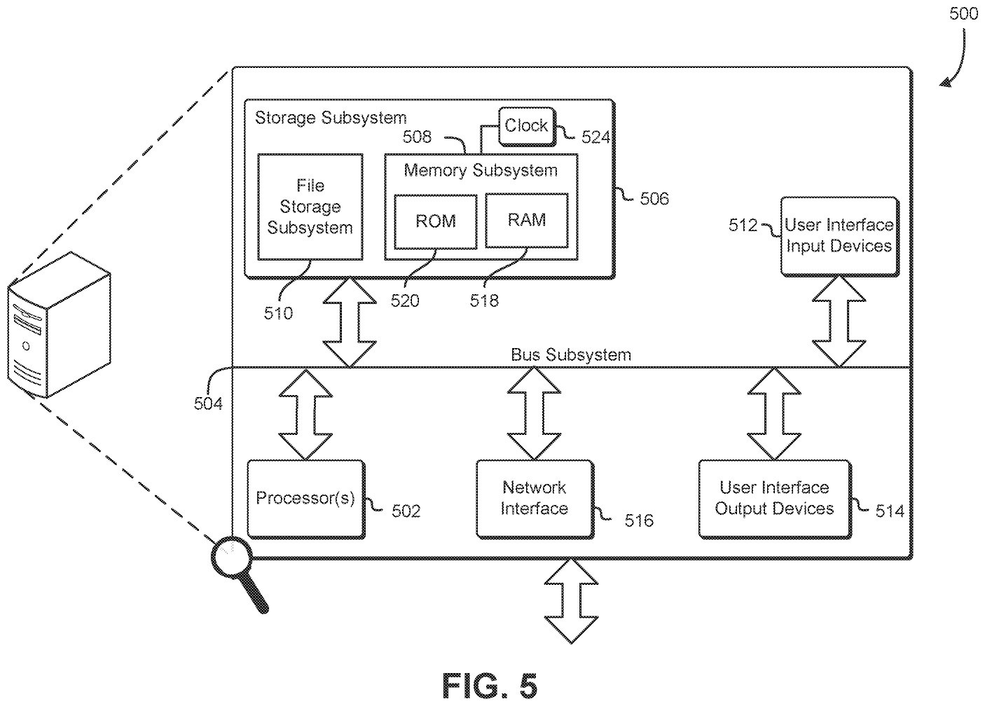

FIG. 4 is a flowchart illustrating an example of a process 400 for training a machine learning model in accordance with various embodiments. Some or all of the process 400 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 400 may be performed by any suitable system, such as the computing device 500 of FIG. 5. The process 400 includes a series of operations wherein a machine learning model is trained on randomly selected nodes, a prediction set of top ranked nodes labeled as an element of interest is generated, the highest-ranked negative nodes are tagged as “hard” (i.e., indicated as incorrectly ranked nodes that are confusing to the machine learning classifier), and the training of the machine learning model continues with the hard-tagged nodes in addition to the randomly sampled nodes.

In 402, the system performing the process 400 obtains a selection of random nodes of at least one web page and the machine learning model is trained on this selection of random nodes over a period of epochs. In some examples, “epochs” refer to stochastic gradient passes (also called “cycles”) over the data. It is contemplated that such web pages may be downloaded from one or more providers, whereupon each of the web pages may be transformed into a DOM tree with elements of the web page making up the nodes of the DOM tree. These nodes may be stored in a data store or a file, and at 402 the nodes may be retrieved from the data store or file. Depending upon the particular implementation, the nodes may be tokenized and/or transformed into feature vectors, which may be stored as a file or in a data store in lieu of storing the node. Otherwise, the node may be tokenized and transformed into the feature vector in 402. It is contemplated that the number (N) of epochs may be a fixed or variable number.

In 404, the system performing the process 400 generates a prediction set of the top-ranked nodes being an element of interest. Examples of the prediction set may be seen in FIGS. 2A-2C. In 406, the system performing the process 400 tags or identifies the highest-ranked negative nodes as “hard” (i.e., non-true positive elements that the initially trained machine learning model 116A of FIG. 1 assigns too high of a confidence score). The highest-ranked negative nodes may then be tagged/selected in a process that is similar to FIGS. 2A-2C.

In 408, the system performing the process 400 re-trains the machine learning model, being sure to include the “hard” nodes in the re-training dataset in addition to the randomly sampled nodes. The training with both categories of nodes may be similar to the process of creating the re-training dataset 114 in FIG. 1B. Note that one or more of the operations performed in 402-08 may be performed in various orders and combinations, including in parallel.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

FIG. 5 is an illustrative, simplified block diagram of a computing device 500 that can be used to practice at least one embodiment of the present disclosure. In various embodiments, the computing device 500 includes any appropriate device operable to send and/or receive requests, messages, or information over an appropriate network and convey information back to a user of the device. The computing device 500 may be used to implement any of the systems illustrated and described above. For example, the computing device 500 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 500 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 5, the computing device 500 may include one or more processors 502 that, in embodiments, communicate with and are operatively coupled to a number of peripheral subsystems via a bus subsystem. In some embodiments, these peripheral subsystems include a storage subsystem 506, comprising a memory subsystem 508 and a file/disk storage subsystem 510, one or more user interface input devices 512, one or more user interface output devices 514, and a network interface subsystem 516. Such storage subsystem 506 may be used for temporary or long-term storage of information.

In some embodiments, the bus subsystem 504 may provide a mechanism for enabling the various components and subsystems of computing device 500 to communicate with each other as intended. Although the bus subsystem 504 is shown schematically as a single bus, alternative embodiments of the bus subsystem utilize multiple buses. The network interface subsystem 516 may provide an interface to other computing devices and networks. The network interface subsystem 516 may serve as an interface for receiving data from and transmitting data to other systems from the computing device 500. In some embodiments, the bus subsystem 504 is utilized for communicating data such as details, search terms, and so on. In an embodiment, the network interface subsystem 516 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UPnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 516 is enabled by wired and/or wireless connections and combinations thereof.

In some embodiments, the user interface input devices 512 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems or microphones; and other types of input devices. In general, use of the term “input device” is intended to include all possible types of devices and mechanisms for inputting information to the computing device 500. In some embodiments, the one or more user interface output devices 514 include a display subsystem, a printer, or non-visual displays such as audio output devices, etc. In some embodiments, the display subsystem includes a cathode ray tube (CRT), a flat-panel device such as a liquid crystal display (LCD), light-emitting diode (LED) display, or a projection or other display device. In general, use of the term “output device” is intended to include all possible types of devices and mechanisms for outputting information from the computing device 500. The one or more user interface output devices 514 can be used, for example, to present user interfaces to facilitate user interaction with applications performing processes described and variations therein, when such interaction may be appropriate.

In some embodiments, the storage subsystem 506 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 506. These application modules or instructions can be executed by the one or more processors 502. In various embodiments, the storage subsystem 506 additionally provides a repository for storing data used in accordance with the present disclosure. In some embodiments, the storage subsystem 506 comprises a memory subsystem 508 and a file/disk storage subsystem 510.

In embodiments, the memory subsystem 508 includes a number of memories, such as a main random-access memory (RAM) 518 for storage of instructions and data during program execution and/or a read-only memory (ROM) 520, in which fixed instructions can be stored. In some embodiments, the file/disk storage subsystem 510 provides a non-transitory persistent (non-volatile) storage for program and data files and can include a hard disk drive, a floppy disk drive along with associated removable media, a Compact Disk Read-Only Memory (CD-ROM) drive, an optical drive, removable media cartridges, or other like storage media.

In some embodiments, the computing device 500 includes at least one local clock 524. The at least one local clock 524, in some embodiments, is a counter that represents the number of ticks that have transpired from a particular starting date and, in some embodiments, is located integrally within the computing device 500. In various embodiments, the at least one local clock 524 is used to synchronize data transfers in the processors for the computing device 500 and the subsystems included therein at specific clock pulses and can be used to coordinate synchronous operations between the computing device 500 and other systems in a data center. In another embodiment, the local clock is a programmable interval timer.

The computing device 500 could be of any of a variety of types, including a portable computer device, tablet computer, a workstation, or any other device described below. Additionally, the computing device 500 can include another device that, in some embodiments, can be connected to the computing device 500 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 500 for processing. Due to the ever-changing nature of computers and networks, the description of the computing device 500 depicted in FIG. 5 is intended only as a specific example for purposes of illustrating the preferred embodiment of the device. Many other configurations having more or fewer components than the system depicted in FIG. 5 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object-level interfaces. The computing device 500 may include any appropriate hardware, software, and firmware for integrating with a data store as needed to execute aspects of one or more applications for the computing device 500 to handle some or all of the data access and business logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 500 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers, or other network devices are stored locally and/or remotely, as appropriate.

In an embodiment, the computing device 500 may provide access to content including, but not limited to, text, graphics, audio, video, and/or other content that is provided to a user in the form of HyperText Markup Language (HTML), Extensible Markup Language (XML), JavaScript, Cascading Style Sheets (CSS), JavaScript Object Notation (JSON), and/or another appropriate language. The computing device 500 may provide the content in one or more forms including, but not limited to, forms that are perceptible to the user audibly, visually, and/or through other senses. The handling of requests and responses, as well as the delivery of content, in an embodiment, is handled by the computing device 500 using PHP: Hypertext Preprocessor (PHP), Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 500 typically will include an operating system that provides executable program instructions for the general administration and operation of the computing device 500 and includes a computer-readable storage medium (e.g., a hard disk, random-access memory (RAM), read-only memory (ROM), etc.) storing instructions that if executed (e.g., as a result of being executed) by a processor of the computing device 500 cause or otherwise allow the computing device 500 to perform its intended functions (e.g., the functions are performed as a result of one or more processors of the computing device 500 executing instructions stored on a computer-readable storage medium).

In an embodiment, the computing device 500 operates as a web server that runs one or more of a variety of server or mid-tier applications, including Hypertext Transfer Protocol (HTTP) servers, FTP servers, Common Gateway Interface (CGI) servers, data servers, Java servers, Apache servers, and business application servers. In an embodiment, computing device 500 is also capable of executing programs or scripts in response to requests from user devices, such as by executing one or more web applications that are implemented as one or more scripts or programs written in any programming language, such as Java®, C, C #, or C++, or any scripting language, such as Ruby, PHP, Perl, Python, or TCL, as well as combinations thereof. In an embodiment, the computing device 500 is capable of storing, retrieving, and accessing structured or unstructured data. In an embodiment, computing device 500 additionally, or alternatively, implements a database, such as one of those commercially available from Oracle®, Microsoft®, Sybase®, and IBM® as well as open-source servers such as MySQL, Postgres, SQLite, and MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs, or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references cited, including publications, patent applications, and patents, are hereby incorporated by reference to the same extent as if each reference were individually and specifically indicated to be incorporated by reference and were set forth in its entirety.

What is claimed is:

1. A computer-implemented method, comprising:
obtaining a set of document object model (DOM) trees that correspond to a set of sample web pages, wherein an individual DOM tree of the set of DOM trees includes a node that has been determined to correspond to a particular classification, wherein the node represents an element on a web page;
generating a first training dataset from the set of DOM trees, the first training dataset including at least one pair of values that include:
a feature vector corresponding to a node in a first DOM tree of a first web page; and
a label corresponding to the particular classification;
for at least one epoch, training, by providing the first training dataset as input to a machine learning model that implements a classifier, the machine learning model to classify DOM nodes of web pages, thereby producing a first trained machine learning model;
generating a prediction set by providing a set of feature vectors derived from nodes of second DOM tree of a second web page to the first trained machine learning model, wherein the prediction set includes top-ranked nodes that do not correspond to the particular classification;
indicating the top-ranked nodes as being confusing to the classifier; and
re-training, by providing a second training dataset that includes at least the top-ranked nodes as negative-examples to the machine learning model, the machine learning model to produce a second trained machine learning model.

2. The computer-implemented method of claim 1, wherein the first training dataset further includes feature vectors and labels corresponding to nodes stochastically selected from the individual DOM tree.

3. The computer-implemented method of claim 1, wherein the top-ranked nodes are ranked by the classifier as being more likely to be the particular classification than a true positive node.

4. The computer-implemented method of claim 1, wherein the top-ranked nodes are a predetermined number of top-ranked nodes that were ranked by the classifier as being more likely than any other top-ranked nodes to be the particular classification.

5. A system, comprising:
one or more processors; and
memory including computer-executable instructions that, if executed by the one or more processors, cause the system to:
obtain a first set of objects, wherein an object of the first set of objects is assigned a classification;
generate a first dataset based at least in part on the first set of objects, the first dataset including:
a value corresponding to at least one characteristic of the object; and
a label corresponding to the classification;
train a machine learning model to classify objects using the first dataset as training input;
generate, using the machine learning model, a set of predictions for a second set of objects that includes incorrect predictions;
generate a second dataset that includes negative-examples that correspond to the incorrect predictions; and
re-train the machine learning model using the second dataset as training input.

6. The system of claim 5, wherein the negative-examples correspond to a distributed sampling of the incorrect predictions across a range of the incorrect predictions.

7. The system of claim 5, wherein the computer-executable instructions further include instructions that cause the system to, after the machine learning model is retrained:
receive, from a client device, a request to identify which element in a web page corresponds to the classification; and
responsive to the request:
transform elements of the web page into feature vectors;
input the feature vectors into the machine learning model;
receive, from the machine learning model, a prediction set that indicates likelihood of the elements corresponding to the classification; and
respond, to the client device, with an indication of which element of the elements most likely corresponds to the classification based on the prediction set.

8. The system of claim 5, wherein the first set of objects is a set of nodes of a document object model of a web page.

9. The system of claim 5, wherein the classification is a type of interface element in a web page.

10. The system of claim 5, wherein each prediction of the set of predictions is a computed probability of a second object of the second set of objects corresponding to the classification.

11. The system of claim 5, wherein the computer-executable instructions that cause the system to generate the first dataset based at least in part on the first set of objects includes instructions that cause the system to derive a set of values for the first dataset from characteristics of the first set of objects.

12. The system of claim 5, wherein the object is a solitary object of the first set of objects that corresponds to the classification.

13. A non-transitory computer-readable storage medium having stored thereon executable instructions that, if executed by one or more processors of a computer system, cause the computer system to at least:
obtain a document object model (DOM) tree that corresponds to a sample web page, wherein the DOM tree includes a node that corresponds to a classification;
generate a first dataset based at least in part on the DOM tree, the first dataset including:
a vector corresponding to the node; and
a label for the node that corresponds to the classification;
provide the first dataset as training input to a machine learning model to thereby produce a first trained machine learning model for ranking whether elements of web pages correspond to the classification;
use the first trained machine learning model to produce a set of rankings for nodes of a second web page, wherein the set of rankings includes highly ranked unlabeled nodes that do not correspond to the classification; and
provide a second dataset that includes at least the highly ranked unlabeled nodes as negative-examples to the machine learning model, the machine learning model to produce a second trained machine learning model.

14. The non-transitory computer-readable storage medium of claim 13, wherein the highly ranked unlabeled nodes were ranked by the machine learning model as being more probable to correspond to the classification than a node in the second web page that actually corresponds to the classification.

15. The non-transitory computer-readable storage medium of claim 13, wherein the executable instructions that cause the computer system to generate the first dataset include instructions that cause the computer system to generate the first dataset from a subset of nodes in the DOM tree that is smaller than a set of all nodes in the DOM tree.

16. The non-transitory computer-readable storage medium of claim 13, wherein the vector is a value that represents a plurality of characteristics of a HyperText Markup Language element corresponding to the node.

17. The non-transitory computer-readable storage medium of claim 13, wherein the executable instructions that cause the computer system to use the first machine learning model to produce the set of rankings further comprises instructions that cause the computer system to, for a web page from which the first dataset was derived:
provide, as input to the machine learning model, vectors corresponding to element nodes of the web page; and
in response to providing the vectors, receive the set of rankings from the machine learning model, the set of rankings including probabilities of the element nodes corresponding to the classification.

18. The non-transitory computer-readable storage medium of claim 17, wherein the executable instructions further include instructions that cause the computer system to:
identify a subset of the element nodes with probabilities in the set of rankings that exceed a threshold probability but that do not correspond to the classification; and
select, as the highly ranked unlabeled nodes, a number of nodes from the subset of the element nodes whose probabilities are higher than probabilities of other nodes of the subset of nodes.

19. The non-transitory computer-readable storage medium of claim 13, wherein the first dataset further includes:
a plurality of other vectors corresponding to other nodes of the DOM tree, the other nodes not including the node; and
at least one of other label for the plurality of other vectors, the at least one other label corresponding to one or more different classifications from the classification.

20. The non-transitory computer-readable storage medium of claim 13, wherein the executable instructions further include instructions that further cause the computer system to use the second trained machine learning model to produce another prediction set for a third web page, wherein a highest probability for an element node of the other prediction set is lower than a highest probability for an element node of the prediction set.
